(19) United States
(12) Patent Application Publication
(10) Pub. No.: US 2011/0200478 A1
(43) Pub. Date: Aug. 18, 2011

(54) Inorganic structures with controlled open cell porosity and articles made therefrom

(76) Inventors: Romain Louis Billiet, Penang (MY); Hanh Thi Nguyen, Penang (MY)

(21) Appl. No.: 12/705,605

(22) Filed: Feb. 14, 2010

(51) Int. Cl. B22F 3/11; B29C 44/00; B29C 44/56

(52) U.S. Cl. 419/2; 264/50; 264/414

(57) ABSTRACT

Structural inorganic cellular materials with controlled open porosity are produced by foaming fine particulate-laden aqueous solutions into stable, uniform, dodecahedral froth structures which are dried and sintered by microwave energy or high voltage instant electrical discharge. Porous open cell biomedical implants such as niobium or tantalum acetabular caps with engineered osteoconductive porosity are among the products achievable.

### CROSS-REFERENCE TO RELATED APPLICATIONS

Not Applicable

### REFERENCES CITED

U.S. PATENT DOCUMENTS

| | | | |
|---|---|---|---|
| 4,443,404 | April 1984 | Tsuda et al. | 419/2 |
| 4,569,821 | February 1986 | Duperray et al. | 419/2 |
| 5,184,286 | February 1993 | Lauf et al. | 361/529 |
| 5,282,861 | February 1994 | Kaplan | 623/16 |
| 5,772,701 | June 1998 | McMillan et al. | 29/25.03 |
| 5,881,353 | March 1999 | Kamigata et al. | 419/2 |
| 5,972,284 | October 1999 | Lindsten et al. | 419/2 |
| 6,103,149 | August 2000 | Stankiewicz | 264/29.1 |
| 6,740,287 | May 2004 | Billiet et al. | 264/669 |
| 6,953,120 | October 2005 | Deveau et al. | 209/10 |
| 7,347,967 | March 2008 | Kim et al. | 419/2 |
| 2007/0196230 | August 2007 | Hamman et al. | 419/2 |
| 2008/0199720 | August 2008 | Liu | 428/613 |
| 2009/0292365 | November 2009 | Smith et al. | 623/23.55 |

Foreign Patent Documents

Other Publications

Bobyn, J. D.; Pilliar, R. M.; Cameron, H. U.; Weatherly, G. C.: “The optimum pore size for the fixation of porous-surfaced metal implants by the ingrowth of bone”—Clinical Orthopaedics and Related Research, Volume 150, Issue, July-August 1980, Pages 263-70

National Research Council Canada: “Highlights—Innovation in Biomaterials: Titanium foams for Tissue Attachment”—National Research Council Canada, News and Events, Oct. 3, 2003

Tuchinskiy, L.; Loutfy, R.: “Titanium foams for medical applications”—Advanced Materials & Processes, Vol. 161, Issue 11, December 2003, Pages 32-3

DePuy Orthopaedics: “Porous titanium coating approved by U.S. FDA”—Advanced Materials & Processes, Vol. 166, Issue 4, April 2008, Page 46

Biomet, Inc.: “Regenerex® Porous Titanium Construct”—Website of Biomet, Inc. www.biomet.com

Medlin, D. J.; Charlebois, S.; Swarts, D.; Shetty, R.; Poggie, R. A.: “Metallurgical Characterization of a Porous Tantalum Biomaterial (Trabecular Metal) for Orthopaedic Implant Applications”—Advanced Materials & Processes, Vol. 161, Issue 11, December 2003, pp. 31-32

Cramer, B.: “Implant may aid in regrowth of bones”—Reporter, Vanderbilt Medical Center's Weekly Newspaper, Jan. 15, 1999

Macheras, G. A.; Papagelopoulos, P. J.; Kateros, K.; Kostakos, A. T.; Baltas, D.; Karachalios, T. S.: “Radiological evaluation of the metal-bone interface of a porous tantalum monoblock acetabular component”—Journal of Bone and Joint Surgery—British Volume, Vol. 88-B, Issue 3, March 2006, Pages 304-9

Macheras, G.; Kateros, K.; Kostakos, A.; Koutsostathis, S.; Danomaras, D.; Papagelopoulos, J.: “Eight- to Ten-Year Clinical and Radiographic Outcome of a Porous Tantalum Monoblock Acetabular Component”—The Journal of Arthroplasty, Volume 24, Issue 5, August 2009, Pages 705-9

Boyle, E.: “Trabecular metal tibial component hailed as viable alternative to cemented implant”—Orthopaedics Today, June 2006

Ultramet: “Refractory Open-Cell Foams: Carbon, Ceramic, and Metal—Ultramet website—www.ultramet.com

Gallego, N. C.; Klett, J. W.: “Carbon foams for thermal management”—Carbon, Vol. 41, 2003, Pages 1461/6

Hunt, E. C.; Wang, Y.: “Application of Vitreous and Graphitic Large-Area Carbon Surfaces as Field-Emission Cathodes”—Applied Surface Science, Vol. 251, 2005, pp. 159-163

Crozier, R. D.: “Flotation. Theory, Reagents and Ore Testing”—Pergamon Press, 1992, ISBN 0-08-041864-3

Gibson, L. J.; Ashby, M. F.: “Cellular Solids, Structure and Properties—Second Edition”—Cambridge University Press, 1997, ISBN 0 521 49911 9

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

1. Field of Invention

The present invention relates to an improved and cost-efficient method for producing structural inorganic cellular materials having uniform, spherical, isotropically distributed, controlled open porosity and to useful articles made therefrom. More specifically, the invention relates to a method for producing biomedical implants, such as but not limited to porous tantalum acetabular cups, with optimized osteoconductive properties.

2. Description of Prior Art

Inorganic open cell porous materials are used in numerous applications such as filters, casting cores, bearings, heat exchangers, sound absorbers, electrochemical cathodes, capacitors, fuel cells, catalyst supports, magnetic shielding, lightweight structures, orthopedic implants, and the like. The particular application of such porous structures dictates their properties such as density, mechanical, thermal and electrochemical properties and the amount and type of porosity.

Such open cell porous materials are produced by a variety of techniques which can be broadly grouped into two main categories, depending on whether the porosity is generated with or without the help of pore forming agents (PFAs).

When no PFAs are used, metal and/or ceramic particulates, usually admixed with about 20-50 volume percent of an organic binder to provide transient rheology to the mixture, are shaped into a green body. Following extraction of the binder, the green part is partially sintered to yield a porous body. Clearly, the amount of porosity that can be achieved with this method cannot exceed that originally present in the green part. Pores thus obtained are randomly shaped and unevenly distributed.

When PFAs are used, porosity well above the plus or minus 50% threshold of non-PFA methods can be attained. Pore generation methods using PFAs include foaming techniques and space holding agents.

Foaming techniques are carried out by blowing gases into a melt or by adding chemical foaming agents to the green body such as titanium hydride which releases a substantial amount of gas upon heating thereby generating bubbles. The resulting porosity is determined by the fairly chaotic dispersion of the gas.

Space holding agents are degradable sacrificial materials incorporated into the green body for no other reason but to monopolize space that would otherwise be occupied by the particulates. Once removed, the void space left behind by space holding agents constitutes porosity. The use of space holding agents provides some degree of control over pore size and shape.

For example, U.S. Pat. Application No. 2008/0199720 by Liu describes a process for manufacturing a porous metal implant by mixing a metal powder with salt as a PFA. After forming the green part, the salt is dissolved in water and the resulting metal skeleton is sintered. Porosity above 65% is claimed.

U.S. Pat. Application No. 20070196230 by Hamman et al. describes a similar process using a liquid botanical compound as a binder and hydrogen peroxide as a PFA. Porosity up to 80% is claimed.

Several variants of the space forming method exist, e.g. the deposition technique which involves the deposition of metal or ceramic vapor, particles or slurries onto polymer foams, burning off the polymer and sintering the remaining skeleton to obtain porous articles having low density and open cell porosity. Control over pore geometry by this method is far less extensive than for PFA techniques. Moreover the struts of the cellular material are typically hollow when organic sponge templates are used.

For example, U.S. Pat. No. 5,881,353 by Kamigata et al. discloses a method for producing a porous body with high porosity by coating a urethane foam with an adhesive to impart stickiness to the surface of the foam, and thereafter with a powder such as copper oxide powder. Following removal of the urethane substrate the metallic skeleton is sintered.

While providing a degree of control over pore formation, there unfortunately remain significant limitations inherent to PFA-based techniques, either through limits on the thickness of the porous article to be formed or through pore anisotropy.

A recent and burgeoning field of use of open cellular structures is that of medical implants designed for biological fixation to host bone. These implants require osteoconductive porosity, i.e. porosity conducive to osseointegration or osteointegration, the direct structural and functional connection between living bone and the surface of a load-bearing implant.

The success of such implants places stringent requirements on their biocompatibility, mechanical properties, intimate contact with the host bone, and stability during the early stages of implantation. A large amount of interconnected porosity is essential to allow unimpeded access to the implant by the front of osteoblasts. Any areas with closed porosity, constrictions or cul de sacs may impede the progress of osteoblasts or restrict vascular support to the ingrowing bone or tissue. This may in turn lead to ischemia, bacterial colonization, stress shielding, low fatigue strength or dislodging of the implant.

Studies show that pore sizes less than 10 microns prevent ingrowth of cells; pore sizes of 15-50 microns encourage fibrovascular ingrowth; pore sizes of 50-150 microns result in osteoid formation and pore sizes greater than 150 microns facilitate the ingrowth of mineralized bone. In a paper entitled “The optimum pore size for the fixation of porous-surfaced metal implants by the ingrowth of bone” (Clinical Orthopaedics and Related Research, Vol. 150, July-August 1980), Bobyn et al. substantiate these findings by indicating a pore size range of 50-400 microns as the optimum for maximum fixation strength.

An osseous implant must distribute stresses throughout its structure, the ingrowing bone and the surrounding bone in order to avoid bone resorption and weakening caused by stress shielding. Any material used for osseous implants must therefore allow elastic deformation and load distribution. As a result, the properties of implants should match those of the host bone as closely as possible. This is particularly the case in hip and knee implants where most of the bone replaced by the implant is cancellous or trabecular bone, the soft porous medullary material found inside cortical bone, the bone's solid outer shell. Studies show that implants with porosity mimicking the porous cellular architecture of cancellous bone have the highest rate of success.

Attempts at producing such biomimetic materials include macroscopic porous coatings, e.g. metal microspheres or wires sintered or otherwise attached to a bulk surface; microscopic surface porosity, e.g. metal powder particles flame- or plasma-sprayed onto a bulk surface; and controlled surface undulations machined into a bulk surface.

For example, Tuchinskiy et al., in an article entitled: “Titanium foams for medical applications” describe a novel method to fabricate titanium foams that emulate the architecture of natural bone by pressing together and sintering titanium tubules, resulting in a material with up to 95% anisotropic porosity.

U.S. Pat. Application No. 2009/0292365 by Smith et al. discloses a method to produce a rough surface on a metallic orthopedic implant by salt blasting the surface of a green part prior to sintering. This results in a surface having about 63% porosity and 300 micron pore diameter. The surface treatment is claimed to shorten the time needed for biological fixation of this implant marketed under the trade name Gription® by DePuy Orthopaedics, Inc., Warsaw, Ind.

Biomet Orthopedics, Warsaw, Ind. market a proprietary porous titanium material for knee, hip and shoulder reconstruction having about 67% porosity under the trade name Regenerex® while claiming superior bone ingrowth, strength and flexibility over similar products made by competitors.

U.S. Pat. No. 5,282,861 by Kaplan (“Kaplan”) teaches a method to produce a porous body suitable as a substitute for cancellous bone. The process, a spin-off of porous materials development for aerospace applications, consists of growing a typically 50 micron thick epitaxial tantalum or niobium film onto a reticulated vitreous carbon (RVC) substrate by chemical vapor deposition (CVD).

The open cell porosity of biomedical implants based on Kaplan's porous metal is remarkably similar to that of natural cancellous bone and is claimed to be unequaled by any other porous metallic implant materials.

Porous tantalum coated biomedical implants putting Kaplan's method to use are commercialized by Zimmer Inc., Warsaw, Ind., under the trade name Trabecular Metal™ and have proved extremely successful in clinical trials, some spreading over 10 years.

However, despite their outstanding and well-documented success record in the field, such implants still suffer from drawbacks. By far the biggest of these is the complex, time-consuming, polluting and costly manufacturing sequence, starting with the fabrication of an open-cell polyurethane (PU) foam. This done by blowing a foaming gas through the molten polymer to generate bubbles which collect into a more or less uniform framework of polyhedra initially separated from each other by thin membranes. Reticulation is achieved when the membranes are ruptured under the effect of gas pressure thus allowing the foaming gas to escape. This leaves behind an open pore structure that is neither entirely uniform nor isotropic. Although the majority of pores are dodecahedral in shape, the material displays smaller pores between larger ones. Also the holes generated by foaming are not always smooth. All these defects can be readily observed in published micrographs of RVC foams.

Next comes the protracted pyrolysis of the PU foam into an RVC precursor as taught by Stankiewicz, U.S. Pat. No. 6,103,149, who cites curing times of up to 15 hours, followed by up to 60 hours to complete the pyrolysis. Adding up all the ramps and soaks, the entire process may take more than four days. During pyrolysis, the cells of the PU foam tend to distort. For functionality reasons, they must be mechanically rectified to bring their aspect ratio from an initial 1.3-1.4 range to between 0.8 and 1.2. Also, during PU pyrolysis, small quantities of hydrocyanic acid may be given off.

Finally, the epitaxial growth of a thin tantalum or niobium film onto the RVC precursor is another lengthy process, conducted under high vacuum in an atmosphere of hydrogen and chlorine gas and generating hydrogen chloride as a by-product.

The presence of a vitreous carbon core, visible as concave triangles in cross sections of RVC struts is another problem as it ultimately determines the strength of the porous biomaterial since the metal coating is very thin. The surfaces of tantalum coated implants produced via Kaplan's method are reportedly also not particularly strong and even the manufacturer cautions against using Trabecular Metal™ implants in areas where bone quality is poor or incapable of providing good initial fixation. Finally, the amount of porosity that can be achieved by Kaplan's method is limited to that initially present in the PU foam.

It is clear from the foregoing that prior art cellular biomaterials suffer from shortcomings ranging from lack of strength, non-uniform or anisotropic porosity and high manufacturing cost. Thus there is a need in the art for a more efficient process for the fabrication of porous articles in terms of pore morphology, functionality and the economics of the pore forming process. Any improvements in the design of porous biomedical implants and especially reductions in their cost of fabrication would benefit patients in need of such articles. Also, many an orthopedic surgeon would welcome the advent of a method capable of producing porous biomedical implants in which functionally optimized porosity could be precisely engineered rather than having to settle for the heuristic outcome of some manufacturing process not originally intended for the fabrication of such products.

### BRIEF SUMMARY OF THE INVENTION

In accordance with the present invention there is provided a method to efficiently and economically fabricate cellular materials with controlled, isotropically distributed, uniform, spherical open porosity.

In a first step of the instant invention, an algorithm is used to establish the necessary basic processing parameters to yield the desired pore cell diameter and amount of porosity in the cellular end product. These parameters are the bubble diameter of a stabilized, uniform, aqueous froth and the volume fraction of particulate matter to be incorporated into the froth in order to yield the desired porosity in the intended cellular end product.

In a next step, de-aggregated, micron- or submicron-sized metal or ceramic particulates, rendered hydrophobic by adsorbing suitable collectors onto their surface, are dispersed into an aqueous foaming solution in the quantity corresponding to the aforementioned predetermined volume fraction.

The foaming solution is then foamed into a stable froth consisting of substantially equally-sized bubbles of the predetermined diameter. The froth adopts a three dimensional structure consisting of uniform, dodecahedral-shaped cells separated by thin pentagonal-shaped films of inter-bubble liquid (membranes). The particulates gather at the edges of the dodecahedral cells thereby forming a framework of struts.

In a next step, the froth is shaped into a desired configuration by casting, molding, extrusion or other forming technique, followed by drying, removal of any organic material and sintering, preferably by microwave energy or high voltage instant electrical discharge.

### Objects and Advantages

It is a primary object of this invention to provide a method to economically produce inorganic cellular materials with controlled, isotropic and uniform open porosity.

It is another object of this invention to provide a manufacturing process for inorganic cellular parts with controlled, isotropic and uniform open porosity ranging from about 75-99%.

Yet another object of the present invention is to provide a manufacturing process for open cellular materials from micron- and submicron-sized particulates.

Still another object of the present invention is to provide a manufacturing process for open cellular materials with predetermined cell sizes.

A still further object of the present invention is to provide a method to fabricate open cellular biomedical implants having engineered osteoconductive porosity.

A still further object of the present invention is to provide a manufacturing process for open cellular materials by microwave energy sintering.

A still further object of the present invention is to provide a manufacturing process for open cellular materials by high voltage instant electrical discharge sintering.

### BRIEF DESCRIPTION OF THE SEVERAL VIEWS OF THE DRAWINGS

FIG. 1 shows a cross section of a dodecahedron entrapping a gas bubble having a radius smaller than the dodecahedron's apothem. The resulting porosity is closed.

FIG. 2 shows a dodecahedron entrapping a gas bubble having a radius of 85% of the dodecahedron's circumradius. The resulting open porosity is 88.9%

FIG. 3 shows a dodecahedron entrapping a gas bubble having a radius of 92% of the dodecahedron's circumradius. The resulting open porosity is 98.4%

FIG. 4 shows a fragment of a 98.4% open porosity structure obtained in accordance with the present invention. The fragment consists of four contiguous dodecahedra as per FIG. 3.

FIG. 5 is a graph showing open cell porosity versus cell radius in a dodecahedral foam structure.

FIG. 6 is an algorithm allowing the determination of the froth bubble diameter needed to yield an open cellular structure with predetermined cell size and porosity.

### DETAILED DESCRIPTION OF THE INVENTION

In its most elementary form, the method of the instant invention consists of using a stable, uniform, substantially dodecahedral aqueous foam as a scaffold on which the intended cellular body is constructed. This is done by incorporating metal or ceramic particulates into a foaming solution. Upon foaming, the particulates assemble at the dodecahedra's interfaces or cell edges, forming the struts of the intended cellular body. Following extraction of the foaming solution constituents, the remaining skeleton of particulates is sintered. Size uniformity of the foam bubbles translates directly into cell uniformity in the sintered cellular body.

A major objective of the present invention is to provide a method for producing cellular biomedical implants with optimized, osteoconductive porosity. Such articles require strict control over the amount, uniformity, distribution, size and connectivity of the cells. Coated reticulated polymer foams, most notably PU foams, are routinely used for the fabrication of porous biomedical implants. However, viscosity effects during foaming of liquid polymers have a profound effect on the uniformity and topology of the foam cells, often leading to cell distortion. Since the viscosity of plain aqueous foams, i.e. foams substantially devoid of viscosity enhancing additives, is much lower than that of foamed polymers, aqueous foams tend to display a more uniform cellular structure. This inherent advantage over polymer foams is one of the reasons aqueous foams are used in this invention.

A first step then in the present invention is to provide a uniform, stable, substantially dodecahedral, aqueous foam. However, it is well-known that aqueous foams are intrinsically unstable, coarsening over time as liquid drains from the interfacial film between contiguous bubbles under the effect of gravity, eventually causing the films to rupture. Coarsening may also take place by Ostwald ripening whereby smaller bubbles diffuse into larger ones under the effect of differential pressure. Hence, from their original spherical shape at formation, aqueous foam bubbles evolve into a polyhedral structure as they attempt to adopt a minimal surface area arrangement embodying less energy. There are still open questions regarding the optimal tessellation of polyhedra in aqueous foams (Kelvin problem) with the most recently accepted model being the Weaire-Phelan structure consisting of six tetrakaidecahedra and two pentagonal dodecahedra.

Duperray et al. U.S. Pat. No. 4,569,821 (“Duperray”) discovered that by adding a small quantity of protein as a gelling agent to his water-surfactant mixture, coalescence of the aqueous foam bubbles could be inhibited. As a result, Duperray's aqueous bubbles tend to pack together into a substantially uniform dodecahedral foam. Metal powders are stirred into the foam and the metal-foam mixture is rigidified by the incorporation of a polymerizing agent. Initially there is a thin film of metal across the generally pentagonal faces. During heating the faces burst, leaving an open framework behind. In other words, Duperray's pore connectivity is the result of gas pressure buildup during heating.

Lindsten et al. U.S. Pat. No. 5,972,284 (“Lindsten”) likewise uses a protein as gelling agent for his foam formation but does not require a surfactant as he claims his protein fulfills that function. Lindsten adds his metal or ceramic powder before foaming and does not need a polymerizing agent after foaming.

To control the size of their aqueous foam bubbles, both Duperray and Lindsten rely exclusively on vigorous mechanical agitation during foaming. Aqueous foam bubbles produced by agitation vary in size depending on the design and rotational speed of the impeller as well as on the method and rate of gas introduction. During intensive agitation, cavitation may further contribute to chaotic bubble formation.

Consequently, in the present invention, the preferred method of producing uniform aqueous foams is through the use of standard commercial aqueous air foam generators. Such equipment, commonly used for firefighting and for foamed concrete production, can produce a steady stream of identically sized foam bubbles. By varying the orifice of the foam nozzle, as well as the air pressure, the diameter of the foam bubbles can be accurately controlled.

As in Duperray and Lindsten, in this invention, a foaming solution is prepared by adding a water-soluble gelling agent to water. A conventional gelling agent is used, chosen from the group of carboxymethylcellulose; polyvinyl alcohol; agar-agar; and protein-containing substances such as albumin from milk, egg white, lysozyme, bovine albumin, blood plasma protein and whey protein. In this invention, albumin in the form of egg white, with its long history in the culinary arts as a medium for producing stable mousses of uniform consistency, is a preferred gelling agent. Aqueous protein foam concentrates are extensively used as firefighting foam agents.

An ordinary water soluble surface active agent may optionally be added to the foaming solution to enhance foaming, e.g. polyethers or polyglycol ethers, methyl isobutyl carbinol (MIBC), sodium dodecylbenzene sulfonate (SDBS) and polypropylene glycol methyl ethers. The stability of the aqueous froth can be further enhanced by the optional incorporation of stabilizers and or viscosity modifiers such as guar gum, gum arabic and polyurethanes. The viscosity of the aqueous froth can also optionally be controlled by lowering its pH through the addition of dilute hydrochloric acid. The optional addition of foaming agents to the foaming solution and any adjustments to its viscosity depends on the type and morphology of the specific particulate material used to produce the cellular structure.

In a next step in the application of the present invention, drawing on the prior art of the mineral froth flotation industry, de-aggregated, micron- or submicron-sized metal or ceramic particulates are conditioned by physisorbing suitable collectors onto their surfaces in order to render the surfaces hydrophobic. Collectors are well known to those skilled in the art of mineral froth flotation and are chosen based upon their selective wetting properties for the specific metal or ceramic particulates being processed. For fine niobium or tantalum particulates, a preferred collector is sulphosuccinamate as taught by Deveau et al., U.S. Pat. No. 6,953,120, but other suitable surfactants can also be used.

The use of particulates having the optimum particle size is very important in the successful application of the instant invention. As in mineral froth flotation, the attraction between the hydrophobic particulates and the aqueous froth bubbles must overcome the gravitational attraction otherwise the particulates will settle. This is one of the reasons very fine particulates are preferred since their reduced volume inherently means less mass and thus less gravitational attraction. Particulates below 5 microns and more preferably below 1 micron are preferred. In the case of heavy metals such as tantalum with a density of 16.654 g/cm3, the finest available particle size is preferred and even nanoparticulates can advantageously be used provided they are de-aggregated and surfactant-coated using prior art techniques such as taught for example by Billiet et al., U.S. Pat. No. 6,740,287. By contrast, Lindsten is limited to the use of metal powders down to 1 micron and ceramic powders down to 0.1 micron as he claims very small particles result in an overly viscous slurry. Thus the ability to make use of submicron and nanoparticulates constitutes an unexpected and unique advantageous aspect of the present invention.

In the next step in the present invention, the foam bubble diameter required to yield the desired porosity in a dodecahedral cellular structure is determined with the aid of an algorithm. In this context, the cell or pore diameter is defined as the diameter of the largest sphere inscribable in the corresponding dodecahedron, i.e. the pore radius is the dodecahedron's apothem.

To aid in the understanding of the principles underlying the instant invention, it is useful to visualize a hypothetical nascent expanding spherical gas bubble entrapped at the center of a regular dodecahedron. Upon expansion, the gas bubble monopolizes space from the dodecahedron into porosity and will continue to do so until its radius equals the dodecahedron's circumradius. In this context, porosity is defined as the volume of the dodecahedron occupied by the gas bubble divided by the volume of the dodecahedron.

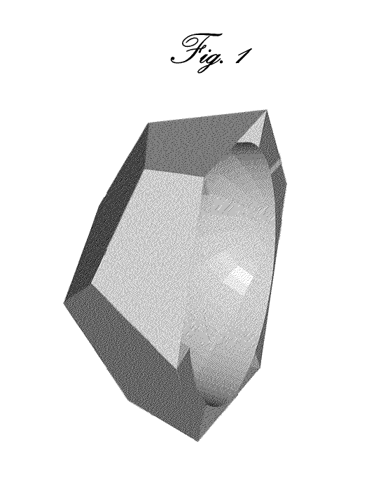

As long as the radius of the expanding gas bubble remains smaller than the dodecahedron's apothem, the porosity will be closed. This is illustrated in FIG. 1 which shows a section through a dodecahedron entrapping a gas bubble whose radius is 77% of the dodecahedron's circumradius.

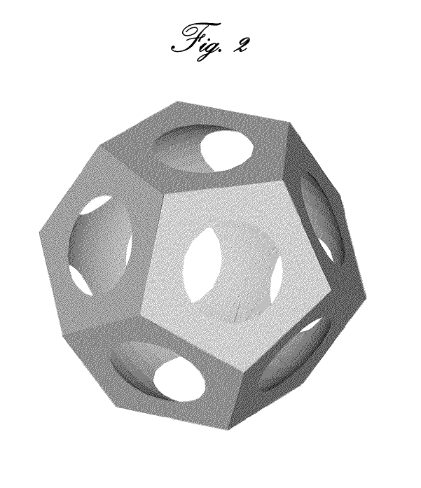

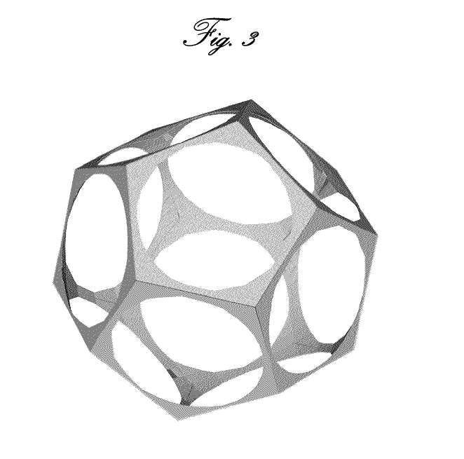

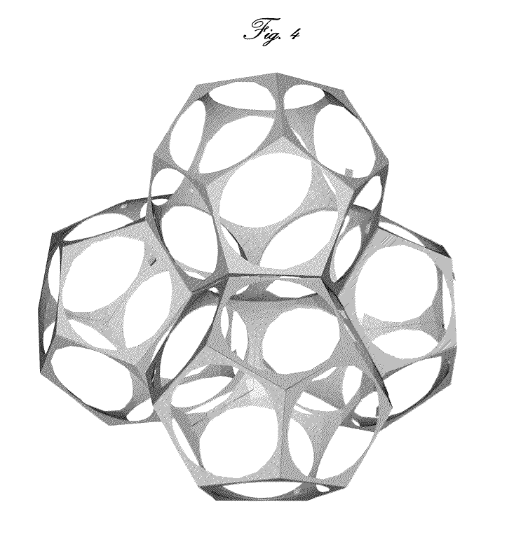

When the gas bubble radius equals the dodecahedron's apothem, the closed porosity reaches a maximum while the open porosity is still zero. Total porosity, defined as the sum of open and closed porosity, is then about 75.5%. When the expanding gas bubble radius exceeds the dodecahedron's apothem, the porosity becomes open as the gas bubble pierces round holes, often called portals, into the dodecahedron's pentagonal faces. This is illustrated in FIG. 2 which shows a dodecahedron entrapping a gas bubble having a radius of 85% of the dodecahedron's circumradius, resulting in 88.9% open porosity. FIG. 3 shows a dodecahedron entrapping a gas bubble having a radius of about 92% of the dodecahedron's circumradius, resulting in 98.4% open porosity. FIG. 4 shows a fragment of a 98.4% open porosity structure achievable by the present invention consisting of an assembly of contiguous dodecahedra.

When the bubble radius equals the dodecahedron's midradius, the open porosity reaches its maximum. Total porosity is then about 99.2% and the struts are at their minimum cross section. When the bubble radius exceeds the dodecahedron's midradius, the struts become discontinuous and can no longer support the dodecahedral structure.

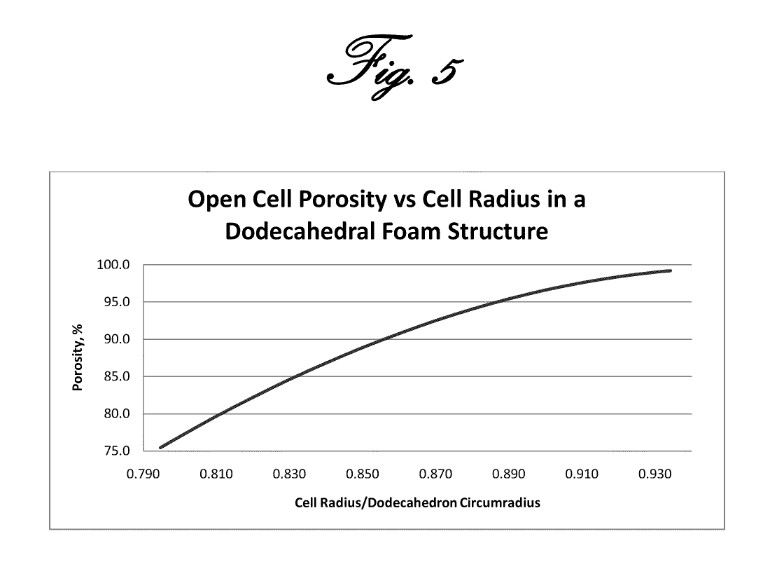

Thus in any regular dodecahedral cellular structure, open porosity can only range from a minimum of about 75.5% to a maximum of about 99.2% and any specific gas bubble radius in the apothem-midradius range corresponds to a unique open porosity value. This is illustrated in the graph of FIG. 5 which shows open porosity in a regular dodecahedral framework as a function of foam bubble radius.

In this invention, this property is exploited in reverse, i.e. a desired open cell porosity and cell diameter correspond to a unique gas bubble diameter. Thus, an open pore structure with given cell size and porosity will be achieved if a foaming solution containing the proper amount of particulate material is foamed into a uniform dodecahedral structure having bubbles of the appropriate diameter. In this invention an algorithm is provided to allow determination of this diameter. The algorithm is based on a structure made up of regular dodecahedra having dihedral angles of 116.57°, i.e. 3.43° short of the 120° needed to completely fill space. In practice however, during foaming, surface tension draws the foam bubbles together into a uniform structure of slightly distorted dodecahedra. This distortion does not affect the reasoning behind the principles of this invention and has no effect on the validity of the algorithm.

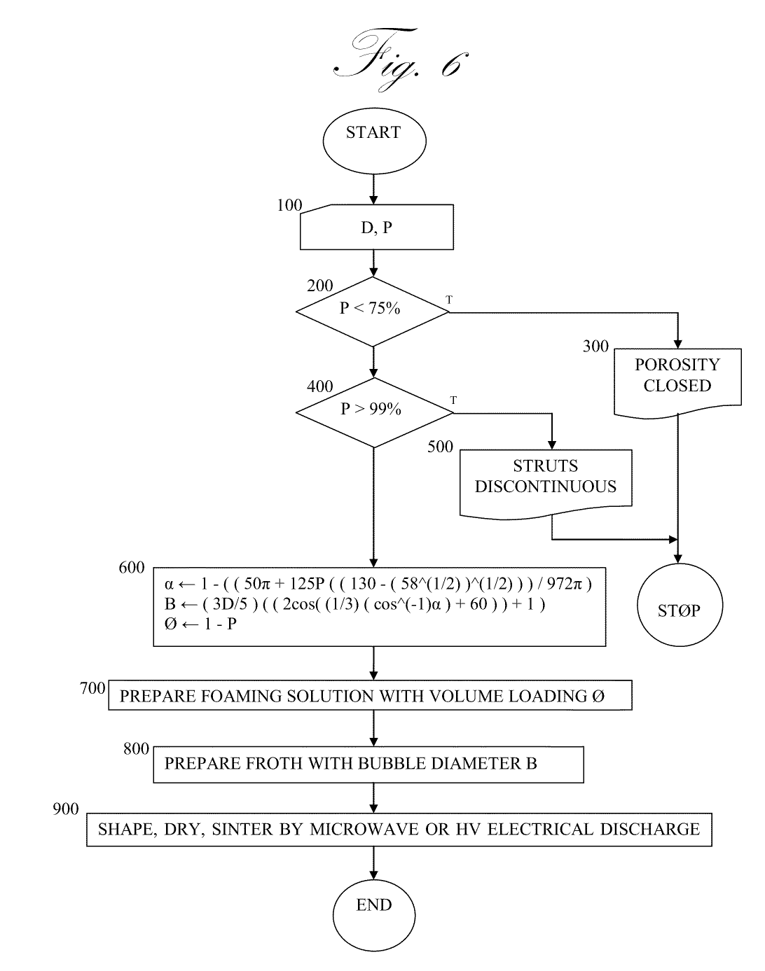

Referring now to FIG. 6 and the numbering of the various steps in the algorithm, the first of these steps (100) is the input of values for D and P, respectively the planned cellular material's cell diameter and porosity with P having to be in the 75-99 percent range for the algorithm to work. The required gas bubble diameter B is obtained by the equation (600):

B=(3D/5)((2 cos((⅓)(coŝ(−1)α)+60))+1)

where B is the gas bubble diameter,

D is the pore cell diameter and

α is given by:

α=1−((50π+125P((130−(58̂(½))̂(½)))/972π)

where P is the porosity.

The dodecahedron's volume fraction not mobilized by porosity is the space available for occupancy by solid matter. Often called the volume loading and represented by the Greek letter Ø, it is given by:

Ø=1−P

As an example, for a desired pore cell diameter of 600 microns (D=600) and a porosity of 90 percent (P=0.9), above equation yields a required gas bubble diameter of 646 microns (B=646) while the volume loading is 10 percent. (Ø=1−0.9).

In the next step of the instant invention, the hydrophobic, de-aggregated, micron- or submicron-sized metal or ceramic particulates are dispersed into the foaming solution in a volume ratio corresponding to the desired porosity. In the above example, one liter of foaming solution will contain 100 ml of hydrophobic particulate matter.

The thus prepared mixture is now foamed into a substantially uniform dodecahedral structure. Surface tension draws the hydrophobic particulates to the dodecahedra's interfaces or cell edges, an energetically more favorable location for the particulates, thus generating the struts of the dodecahedral structure. Once located at these edges, the hydrophobic particulates will remain there in a stable state and contribute to the overall stability of the dodecahedral structure further protecting the foam from premature coalescence. It shall also be noted that by using the algorithm, the prior art issue of pentagonal face obturation during foaming is entirely obviated since the amount of particulate matter in the foam is insufficient to generate this problem. The size of the air foam bubbles is controllable using optical imaging instrumentation or by acoustic bubble spectrometry.

In a next step, the hydrophobic particulate-loaded foam is shaped into the desired end configuration by casting, molding, extrusion or other forming techniques, followed by removal of all aqueous and any organic material from said formed shape by prior art techniques of drying and/or heating in air, in a controlled atmosphere or vacuum.

The final step in the present invention is sintering of the dried porous structure. Sintering of green particulate bodies is habitually associated with densification, in turn synonymous with volumetric shrinkage. Duperray for example cites shrinkages of his porous bodies in the 10-43% range. In the case of the characteristically tenuous cellular structures achievable by the present invention, shrinkage is to be avoided as it will deleteriously affect control over pore size and pore shape uniformity.

Textbooks typically refer to three loosely defined, partly overlapping stages during sintering which, within the context of this invention, can be summarized as:
an initial stage during which inter-particulate necks form and grow and particulate surfaces smoothen out, significantly without shrinkage taking place,
an intermediate stage characterized by the onset of shrinkage and
a final stage during which densification reaches a maximum.

For the successful application of this invention, it is important not to go beyond the first stage. This is very difficult to achieve in practice as sintering is usually performed in electrical resistance heated furnaces or kilns in a gaseous atmosphere or in a vacuum. Temperature gradients in the work zone of such sintering equipment are the rule. Also, during temperature-time profiles, there is usually a hysteresis between actual temperatures of the workload and temperatures sensed by control thermocouples.

Consequently, in this invention, although conventional sintering techniques may be used, sintering of the dried porous structures is preferably done by heating with microwave energy or by high voltage instant electrical discharge.

Microwave sintering, as taught by McMillan et al. U.S. Pat. No. 5,772,701 and Lauf et al. U.S. Pat. No. 5,184,286, both of which are incorporated herein by reference in their entirety, results in better temperature control, lower power consumption and faster sintering. For example, Lauf et al. U.S. Pat. No. 5,184,286 reports microwave sintering of tantalum capacitors in 2 minutes versus 3 hours or more using conventional sintering processes.

Most preferably, in this invention, sintering of dried metal-based cellular structures is by high voltage instant electrical discharge in a vacuum as taught by Kim et al. U.S. Pat. No. 7,347,967 and Tsuda et al. U.S. Pat. No. 4,443,404, both of which are incorporated herein by reference in their entirety. The high voltage instant electrical discharge method allows for accurate real-time temperature measurement.

Both the microwave and the high voltage instant electric discharge sintering methods allow for precise control over interparticulate neck growth and specifically the smoothening of the concave triangular cross section of the green struts into a more convex triangular cross section, thus resulting in enhanced mechanical strength of the struts.

### Conclusion, Ramifications and Scope

In conclusion, the major advantage of the present invention resides in the ability to economically produce structural inorganic cellular materials with uniform, spherical, isotropically distributed, controlled open porosity and useful articles made therefrom.

Specifically, the present invention allows economical fabrication of engineered porous biomedical implants with optimized osteoconductive properties from materials such as tantalum, niobium, titanium, tricalcium phosphate (TCP) and alloys or combinations of these. Examples of these include tantalum or niobium acetabular cups, bone screws, dental implants and the like.

Additionally, the method of the present invention allows fabrication of porous structures that are suitable for a variety of applications such as thermal and acoustic insulating materials, filters, membranes, catalyst supports, fuel cells, lightweight materials and the like.

The practical uses of the present invention are clearly broad in scope and universal in application and attempting to enumerate them all would not materially contribute to the description of this invention.

Although the invention has been described with respect to specific preferred embodiments thereof, many variations and modifications will immediately become apparent to those skilled in the art. It is therefore the intention that the appended claims be interpreted as broadly as possible in view of the prior art to include all such variations and modifications.

1. A method for producing an open cell porous body from sinterable particulate materials, comprising:
a. rendering the surfaces of said sinterable particulate materials hydrophobic by adsorbing a suitable collector on same,
b. preparing a foamable solution of water and a protein substance which is soluble in water at ambient temperatures and capable of forming a gel upon heating,
c. mixing the thus obtained hydrophobic particulate materials into said foamable solution in quantities such that the volume ratio of foamable solution to the total volume corresponds to the planned open cell porosity in said open cell porous body,
d. by means of an algorithm, determining the foam bubble diameter needed to yield a planned pore cell diameter in said open cell porous body,
e. foaming the thus obtained particulate-laden foamable solution into foam bubbles of the predetermined diameter, assembled in a stable froth having a dodecahedral architecture,
f. forming said froth into a green body of the desired shape by molding, casting, extruding, or the like, while heating to the gelling temperature of the protein substance,
g. removing all aqueous and organic constituents from the green body through heating in air, a gaseous atmosphere or in a vacuum, leaving behind a dried, organic-free dodecahedral architecture,
h. sintering said organic-free dodecahedral architecture into an open cell porous body without significant shrinkage taking place during sintering.

2. The method as set forth in claim 1 wherein said foamable solution optionally contains foam enhancing agents such as polyethers or polyglycol ethers, methyl isobutyl carbinol (MIBC), sodium dodecylbenzene sulfonate (SDBS) and polypropylene glycol methyl ethers.

3. The method as set forth in claim 2 wherein said foamable solution optionally contains foam stabilizers and or viscosity modifiers such as guar gum, gum arabic and polyurethanes.

4. The method as set forth in claim 3 wherein the viscosity of said foamable solution is optionally adjusted by lowering its pH.

5. The method as set forth in claim 4 wherein said method for producing an open cell porous body does not require the use of an organic binder.

6. The method as set forth in claim 5 wherein said sinterable particulate materials have an average particle size below one micron.

7. The method as set forth in claim 5 wherein said particulate materials are selected from the group of metals and metal alloys, oxides, nitrides, carbides, including cemented carbides, and mixtures thereof.

8. The method as set forth in claim 7 wherein said sinterable particulate material is tantalum or a tantalum alloy.

9. The method as set forth in claim 7 wherein said sinterable particulate materials is niobium or a niobium alloy.

10. The method as set forth in claim 8 wherein said sinterable particulate material is titanium or a titanium alloy.

11. The method as set forth in claim 8 wherein said sinterable particulate material is zirconium or a zirconium alloy.

12. The method as set forth in claim 5 wherein sintering is done by high voltage electrical discharge in a vacuum.

13. The method as set forth in claim 5 wherein sintering is done using microwave energy.

14. The method as set forth in claim 5 wherein said sintered open cell porous body is an implantable medical device such as a prosthetic hip joint or an oral endosseous implant.

15. The method as set forth in claim 14 wherein said implantable medical device is a dental implantodontic appliance.

16. The method as set forth in claim 14 wherein said implantable medical device is an acetabular cup.

17. The method as set forth in claim 1 wherein the hydrophobic particulate materials are added to the foamable solution after foaming.
